(19) United States
(12) Patent Application Publication
(10) Pub. No.: US 2026/0037958 A1
(43) Pub. Date: Feb. 5, 2026

(54) JEWELRY ASSOCIATED WITH A DIGITAL ASSET

(71) Applicant: DAJPIECES LLC, New York, NY (US)

(72) Inventor: Andrew Penn, New York, NY (US)

(21) Appl. No.: 19/100,179

(22) PCT Filed: Aug. 2, 2023
(86) PCT No.: PCT/US2023/029261

§ 371 Date: Jan. 31, 2025

Related U.S. Application Data
(60) Provisional application No. 63/394,396, filed on Aug. 2, 2022.

(51) Int. Cl. G06Q 20/36; A44C 15/00

(52) U.S. Cl. CPC G06Q 20/367; A44C 15/004; G06Q 2220/00

(57) ABSTRACT

The present invention provides a wearable article with a physical marking denoting a unique digital identifier associated with a digital asset. The wearable article may include a non-fungible token (NFT) of the article, minted concurrently with the purchase of the article, which records and validates the purchase of the article and provides the ability and/or right to wear the article in the metaverse.

### CROSS-REFERENCE TO RELATED APPLICATIONS

This application claims priority to, and the benefit of, U.S. Provisional Application No. 63/394,396, filed on Aug. 2, 2022, the content of which is incorporated by reference herein in its entirety.

### TECHNICAL FIELD

The present invention relates generally to wearable articles associated with a corresponding digital asset, and, more particularly, to jewelry having one or more physical markings denoting a unique digital identifier that is associated with a non-fungible token (NFT) that is tied to, and representative of, the jewelry.

### BACKGROUND

A digital asset is generally anything that exists in digital form and comes with a distinct usage right. Types of digital assets include, but are not limited to, photography, logos, illustrations, animations, audiovisual media, presentations, spreadsheets, digital paintings, word documents, electronic mails, websites, and a multitude of other digital formats and their respective metadata. Digital assets have become increasingly more popular and valuable as technological advances have become integrated into society's personal and professional lives.

Transactions involving the buying and selling of digital assets may take place with the use of a digital wallet. A digital wallet (also generally known as an electronic wallet or crypto wallet) is a financial transaction application that typically runs on mobile devices (i.e., smartphones, tablets, etc.) as well as standard computing devices (PCs and the like). Digital wallets can facilitate the purchase and sale of digital assets, as well as physical assets. In particular, a digital wallet securely stores financial/payment information and passwords, thereby allowing a user to pay for any given item without the need for physical cash, credit cards, debit cards, etc. The payment information in a digital wallet may be tied to a user's bank accounts, credit/debit cards, as well as other forms of funding, such as cryptocurrency.

When a transaction involves a digital asset, typically both the digital asset (to be sold, exchanged, traded, etc.) and the digital wallets (of the respective seller and buyer) contain unique cryptographic identifiers that provide proof of ownership, proof of funds, as well as access to the digital asset. In other words, because there is actually no physical item being exchanged, it is the data associated with the digital asset and the funds to pay for the digital asset that are being exchanged. As such, digital wallets typically store both the cryptocurrencies used in these digital transactions as well as the unique identifier, or cryptographic token, associated with ownership of the digital asset.

With transactions involving the sale, exchange, or trading of an NFT, for example, a determination of authenticity is crucial. An NFT is a non-fungible token, meaning that it can neither be replaced nor interchanged because it has unique properties. Rather, an NFT is a digital asset that represents internet collectibles like art, music, and games with an authentic certificate created by blockchain technology that underlies cryptocurrency. The majority of NFTs reside on the Ethereum cryptocurrency's blockchain, a distributed public ledger that records transactions. As such, NFTs are individual tokens with valuable information stored in them, in that their unique data makes it easy to verify and validate their ownership and the transfer of tokens between owners. Accordingly, transactions involving NFTs, for example, rely on a verification step, in which is determined whether the seller of the NFT is in fact the exclusive owner. Such a verification step includes a determination of whether the associated digital wallet holds the specific, unique cryptographic identifier associated with the NFT. Thus, if a unique cryptographic identifier is lost or stolen, the digital asset may be gone forever in that the verification step cannot be completed and ownership cannot be verified.

### SUMMARY

The present invention provides a physical wearable article that is generally associated with a corresponding digital asset. In particular, the wearable article, which may be in the form of jewelry, includes one or more physical markings denoting a unique digital identifier that is associated with a digital asset. Significantly, in some embodiments, the digital asset includes a non-fungible token (NFT) that is tied to, and representative of, the piece of jewelry, minted concurrently with the purchase of the jewelry, which records and validates the purchase of the jewelry. The piece of jewelry includes a physical marking denoting a unique digital identifier associated with the NFT, such as the address of a digital wallet that has been engraved, etched, or incorporated into the design of the piece of jewelry.

Accordingly, the present invention provides both a physical wearable article and a digital asset, each of which includes a cryptographic identifier (via physical markings in the wearable article and digital data associated with the digital asset). The cryptographic identifier is used for validating the purchase and ownership of the article. Thus, the invention integrates the physical article and the NFT for use in both the physical world and the metaverse (i.e., virtual world), while validating and safeguarding ownership of the digital asset. Furthermore, providing a physical marking denoting the unique digital identifier associated with the NFT may effectively reduce the risk of losing the digital address, thereby reducing risk of losing access to the NFT. For example, the unique digital identifier may be a private key necessary to maintain access to the NFT. Additionally, by providing both a physical piece and an NFT as a single product, one must either exchange (i.e., trade, sell, transfer, etc.) the physical piece to another person in order to also effectuate the transfer of the associated NFT or exchange the NFT to also effectuate a transfer of the associated physical object. In other words, one must transfer both the NFT and the physical piece in order to transfer the single product as a whole. In this way, the security and validity over ownership is strengthened. It should be noted that, in other nonlimiting embodiments, ownership of the NFT may be transferred without having to also exchange (i.e. trade, sell, transfer, etc.) the physical object or vice versa (the ownership of the physical object may be transferred without also having to transfer ownership of the NFT).

In certain aspects, the wearable article is a piece of jewelry, such as a ring, a bracelet, a necklace, a watch, one or more earrings, a pin, anklet, headband, headpiece, and/or a pendant. The piece of jewelry includes one or more physical markings denoting a unique digital identifier associated with a digital asset. For example, the physical marking may be cast, carved, etched, engraved, printed, and/or inked into the jewelry. Furthermore, the physical marking may be incorporated into the wearable article as part of the design of the article. In some embodiments, the digital asset is a cryptographic token having a unique cryptographic code. For example, the cryptographic token may be a payment token, a utility token, a security token and/or a non-fungible token (NFT).

In some embodiments, the physical marking on the wearable article is a set of alphanumeric characters denoting a digital address associated with one or more transactions involving the cryptographic token. The transactions may include sale of the digital asset, trading of the digital asset, and/or transferring ownership of the digital asset. For example, the digital address may be associated with the unique cryptographic code that is stored in a digital wallet. The digital address may be the address of a digital wallet used for the transactions. In some embodiments, the digital address and/or the cryptographic code include data that provides for access to the digital asset, verification of ownership of the digital asset, and/or transactions involving the digital asset. For example, the digital asset and/or the cryptographic code may be used to verify that a digital wallet associated with the owner of the wearable article holds the cryptographic token and indicates exclusive ownership of the digital asset.

In some embodiments, the purchase of the wearable article concurrently generates the cryptographic token and transmits at least one of a digital address and cryptographic code to a digital wallet. Thus, the unique cryptographic code represents a transfer of consideration on a digital ledger of transactions from the digital wallet associated with an owner in exchange for the wearable article and the associated cryptographic token. The digital ledger of transactions may be a blockchain network. For example, the blockchain network may be Ethereum, Solana, Flow, Polygon, World Asset exchange (WAX), Binance Smart Chain (BSC), Tezos, and/or Fantom. In some embodiments, the transmittal of the unique cryptographic code records and validates the purchase of the digital asset.

In some embodiments, the cryptographic token is a non-fungible token (NFT). The design of the NFT may be related to the physical design of the wearable article. Further, in some embodiments, the purchase of the wearable article transfers exclusive rights to use the wearable article in a virtual reality (VR) and/or augmented reality (AR) social network. The NFT may be cryptographically linked to a virtual representation of the NFT with ownership data of the NFT associated with the digital wallet of the owner of the NFT. This virtual representation of the NFT may be associated with the physical design of the wearable article.

### BRIEF DESCRIPTION OF THE DRAWINGS

FIG. 1 is an image of a wearable article in the form of a ring, which includes a unique digital identifier provided as part of the design of the ring.

FIG. 2 is an image of another embodiment of a wearable article in the form of a ring with the unique digital identifier provided as part of the design of the ring.

FIG. 3 is a block diagram illustrating an embodiment of a workflow for the creation of an NFT associated with the purchase of the wearable article.

FIG. 4 is a block diagram illustrating the subsequent purchase of an NFT from one user to another.

FIG. 5 is a block diagram illustrating another embodiment of a workflow for the creation of an NFT associated with the purchase of the wearable article.

### DETAILED DESCRIPTION

The present invention relates generally to a wearable article associated with a corresponding digital asset. Specifically, the wearable article may be jewelry having one or more physical markings denoting a unique digital identifier that is associated with a non-fungible token (NFT). In this case, the NFT is linked to, and representative of, the jewelry.

The following description, and figures referred to herein, are directed to a wearable article in the form of a ring (to be worn on a finger). However, it should be noted that the wearable article may include any type of article that can be worn on a person's body, such as an article of clothing or element of clothing, wearable art, tattoo, a wearable device, or accessory such as a purse or handbag or wallet chain.

For example, the wearable article may include jewelry, including, but not limited to, a bracelet, a necklace, a watch, one or more earrings, a pin, anklet, headband, headpiece, and/or a pendant. The jewelry may be an article worn on the head or in the hair such as a crown, coronet, corolla, circlet or other head gear. In non-limiting examples, the jewelry may be a bolo tie, carcanet, choker, necklace, pendant, or torc, such as a kalabubu, or other article worn on or around the neck. The jewelry may be an armlet, bangle, cuff links, belt buckle, charm, or a bracelet such as a charm bracelet, friendship bracelet or gospel bracelet. The jewelry may be a belly chain, body piercing jewelry, a breastplate, brooch, a belt hook, clasp, pin, or chatelaine. The jewelry may also be an anklet, toe ring, amulet, medical alert jewelry, membership pin, military dog tag, pledge pin, prayer jewelry, puzzle jewelry, or ring, such as a signet ring or thumb ring. In specific embodiments, the piece of jewelry may be a ring, a bracelet, a necklace, a watch, one or more earrings, a pin, anklet, headband, headpiece, and a pendant.

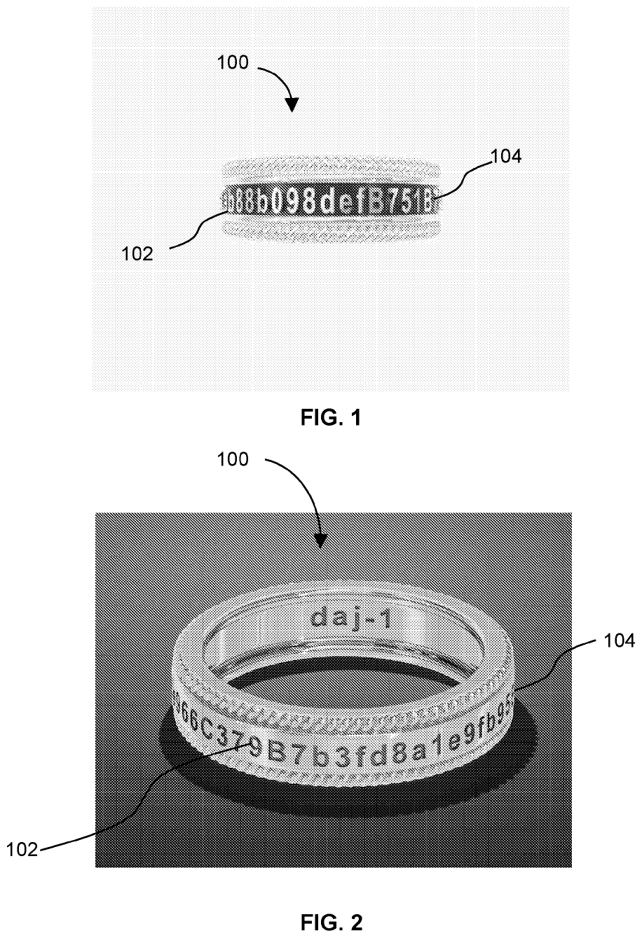

FIGS. 1 and 2 illustrate embodiments of a wearable article 100 (shown as a ring), with a physical marking 102 that is a unique digital identifier 104 associated with a digital asset. In the illustrated embodiments, the unique digital identifier 104 is generally in the form of a set of alphanumeric characters denoting a digital address associated with a unique cryptographic code and is stored in a digital wallet. For example, in some embodiments, the digital asset may include, for example, a non-fungible token (NFT) that is tied to, and representative of, the ring. In other words, a design of the NFT is related to the physical design of the ring. However, it should be noted that the unique digital identifier 104 may be represented in a number of ways, such as an unbroken string of characters or numerals, broken characters and numerals, and the like.

The digital asset, specifically the NFT in this example, is minted concurrently to the purchase of the ring and transmitted to the digital wallet denoted in the ring (via the unique digital identifier), thereby recording and validating purchase (of both the physical ring and the associated NFT).

In some embodiments, the physical marking of the unique digital identifier is cast, carved, etched, engraved, printed, or inked on or into the article. In non-limiting examples, etching may involve producing the unique digital identifier on the wearable article by eating into the surface materials, for example as by an acid or laser beam. Casting may involve melting a material and pouring it into a mold that contains the unique digital identifier. The unique digital identifier may be carved into the wearable article, for example cutting or carving the identifier onto the surface of the wearable article. In some embodiments, the unique digital identifier is incorporated into the design of the wearable article. For example, the digital identifier may be woven into the wearable article.

It should be noted that the digital asset may be a digital representation of any type of object. The digital asset may or may not have an associated value. The digital asset may be anything stored digitally that is uniquely identifiable such that a person can use the asset to realize its value. For example, the digital asset may be a conventional digital asset such as a document, audio, video, a logo, a slide presentation, a spreadsheet and/or a website. The digital asset may be a type of cryptocurrency, stablecoin, or central bank digital currency (CBDB). The digital asset may be a security, a commodity, a derivative or other financial product, real estate, artifacts, articles, or works of art.

For example, the digital asset may be a type of cryptocurrency. Cryptocurrency is a medium of exchange for which generation or ownership records are supported through a distributed ledger technology, such as a blockchain, that relies on cryptography. A distributed ledger system is a network that is distributed across a large number of disparate computers. This decentralized structure allows the system to exist outside the control of governments and central authorities. In a blockchain system, data is shared across the network which creates a digital ledger of verified transactions or information among network participants. The data are typically linked using cryptography to maintain the integrity of the ledger and to execute other functions, including transfer of ownership or value. The digital asset may be any of the block-chain based cryptocurrency and associated blockchain networks, such as Bitcoin, Ethereum, Cardano, Binance Coin, Tether, Solana, XRP, Dogecoin, Polkadot, and USD Coin.

The digital asset may be a stablecoin. Stablecoins are a category of cryptocurrencies with mechanisms that are aimed at maintaining a stable value, such as by pegging the value of the coin to a specific currency, asset, or pool of assets or by algorithmically controlling supply in response to changes in demand in order to stabilize value. CBDC is a form of digital money or monetary value, denominated in the national unit of account, that is a direct liability of a central bank.

The digital asset may be a token. Tokens are also considered a form of cryptocurrency. Tokens may be created and given out through an Initial Coin Offering (ICO) similar to a stock option. Tokens can be represented as value tokens (similar to bitcoins), security tokens (similar to stocks), and utility tokens (designated for specific uses). Tokens may be built and stored on an existing blockchain. The token may be a programmable asset that allows for the creation and execution of a unique smart contract that establishes ownership of assets outside of the blockchain network.

In some embodiments, the digital asset may be a cryptographic token having a unique cryptographic code. For example, the cryptographic token may be a payment token such as cryptocurrency, a utility token, and/or a non-fungible token (NFT). A utility token may provide access to a specific service or product within a blockchain network, or allow a user to perform some action on the network. The security token may give rights of ownership to a company, for example.

As previously noted, the digital asset may be an NFT. An NFT is a unique digital asset stored on a blockchain system and encrypted using a unique code that allows the ownership or the transaction. The NFT may be a digital asset that represents a real-world object, for example art, music, in-game items, or videos. The NFT may link to a digital representation of a real-world object. The NFT may be bought and sold with cryptocurrency. The unique cryptographic code may mean the NFT cannot be replicated and thus the NFT is not mutually interchangeable with other NFTs. The unique cryptographic code may provide a public certificate of authenticity and exclusive right of ownership. The NFT may also include stored metadata associated with the digital asset, for example an artist's signature stored in the file.

The digital asset or digital token may be cryptographically linked by a unique digital identifier to a virtual representation of the respective item. The item may be a digital good, a physical good, a digital service, a physical service, a digital experience, or a physical experience.

In some embodiments, the unique digital identifier that is provided on the wearable article (via a physical marking) is a cryptographic identifier, thus the digital asset is encrypted with cryptography. Cryptography may secure information and communications so that only those person for whom the information is intended can understand it and process it. Mathematical algorithms may be used for cryptographic key generation, digital signing, verification to protect data privacy, web browsing on internet and to protect confidential transactions such as credit card and debit card transactions. The cryptographic identifier may encompass one of three types of cryptography: symmetric key cryptography, hash functions, asymmetric key cryptography. In asymmetric key cryptography, a pair of keys is used to encrypt and decrypt information. A public key is used for encryption and a private key is used for decryption. The public and private keys are different. Thus, even if the public key is known by everyone the intended receiver can only decode it because they alone know the private key. In some embodiments, the cryptographic identifier is a public key. In other embodiments, the cryptographic identifier is a private key.

The digital asset, such as cryptocurrency or NFTs, may be stored in a digital wallet. The digital wallet may be, for example, a cryptocurrency wallet or blockchain wallet, which allows users to store and trade digital assets. The blockchain wallet associated with the user may hold the cryptographic tokens associated with the digital asset or assets. Purchases may be effectuated by facilitating a transfer of consideration on the blockchain from the wallet associated with the user in exchange for the cryptographic token associated with the digital asset. The digital wallet may keep an inventory of the digital assets or tokens owed by the user.

The digital wallet may be an application that functions as a wallet for a user's cryptocurrency. For example, the digital wallet may store the unique cryptographic keys used to sign for cryptocurrency or other digital assets. The digital wallet may contain a public key such as a wallet address as well as a private key or keys needed to sign cryptocurrency transactions. The wallet address may be used for sending and receiving cryptocurrency using the digital wallet, with the transaction signed using a private cryptographic key. The digital wallet may have an integrated QR code and near-field scanner technologies. The digital wallet may be a custodial or noncustodial wallet. A custodial wallet is hosted by a third party and stores the keys for a user. A noncustodial wallet is controlled by the owner, who takes responsibility for securing the cryptographic keys. The digital wallet may be a hardware wallet. Hardware wallets store the private cryptographic keys and remove them from the user's device, thus they do not have an active connection until they are plugged in to a computer or device.

In some embodiments, the physical marking on the wearable article is a set of alpha numeric characters denoting a digital address associated with a transaction involving a cryptographic token. For example, digital address may be associated with a digital wallet used to purchase a cryptographic token.

Transactions may be sent between parties using, for example, a cryptocurrency wallet. The person creating the transaction may use the public wallet address of the wallet and the private cryptographic key associated with the account. The transaction between parties may be encrypted and broadcast to a blockchain or other network to be added to a public (or private) ledger depending on the network. The transfer of a cryptographic digital asset to a digital wallet may include transmitting a unique digital asset code to the distributed blockchain ledger to record on a distinct record block the transfer of the cryptographic digital asset to the purchaser. The transaction may include transmitting to the purchaser a unique key or cryptographic code or address that correlates to ownership of the cryptographic token.

The physical marking on the wearable article may be one or more of the unique alphanumeric keys or codes associated with the transaction. For example, the physical marking may be the address of a digital wallet. The wallet address may be a digital address, made up of letters and numbers, that is used for sending and receiving cryptocurrency transactions. The digital address may be associated with the unique cryptographic code of a digital asset stored in a digital wallet. In some embodiments, the digital address and/or the cryptographic code contain data for providing at least one of: access to the digital asset, verification of ownership of the digital asset; and one or more transactions involving the digital asset.

The transaction may include sale of the digital asset, trading the digital asset, and/or transferring ownership of the digital asset. In some embodiments, the digital address and/or the cryptographic code may be used to verity that a digital wallet associated with the owner of the wearable article holds the cryptographic token and indicates exclusive ownership of the digital asset.

As noted above, the invention provides a wearable article that includes a physical marking denoting a unique digital identifier associated with a digital asset. For example, the physical marking may be the address of a digital wallet. In some embodiments, the invention provides for both a physical, wearable article, and a digital asset, each of which may include a cryptographic identifier for validating the purchase and ownership of the article. In some embodiments of the present invention, the physical, wearable article, is tokenized to include a digital asset. Tokenization is the process where an underlying asset, tangible or intangible, is converted into a digital “token” that acts as its proxy. It is possible to tokenize a wide range of assets, from cash, equity securities, and debt securities to real assets such as real estate, commodities, artifacts, and works of art.

Thus, when the wearable article is purchased, a cryptographic token may be concurrently generated and a digital address and/or a unique cryptographic code transmitted to a digital wallet. The unique cryptographic code may represent a transfer of consideration on a digital ledger of transactions from the digital wallet associated with the owner in exchange for the wearable article and the associated cryptographic token. The transmittal of the unique cryptographic code may record and validate the purchase of the digital asset. The transmittal of the unique cryptographic code may also record and validate the purchase of the wearable article such that the wearable article and the digital asset are inextricably tied. The digital ledger may be a blockchain or other network as described above. For example, the blockchain network may be the Ethereum, Solana, Flow, Polygon, World Asset exchange (WAX), Binance Smart Chain (BSC), Tezos, and Fantom networks.

In some embodiments, the cryptographic token is a non-fungible token (NFT), minted concurrently with the purchase of the wearable article. The NFT may include a link to a virtual representation of the wearable article. In some embodiments, the virtual representation of the NFT is associated with the physical design of the wearable article. For example, the design of the NFT may be related to the design of the wearable article. The design of the NFT may exactly match the design of the wearable article. The design of the NFT may mirror the design of the wearable article. The design of the NFT may be complementary to the design of the wearable article. The NFT may have elements of the design of the wearable article. For example, the NFT may match in color, border, shape or other aspects of the design.

Because the NFT may be minted concurrently with the purchase of the wearable article, the cryptographic code may include the right and/or ability to wear or use the wearable article in a virtual reality (VR) and/or augmented reality (AR) social network. For example, purchase of the wearable article may include the right and/or ability to use the wearable article in the metaverse. The metaverse is a hypothetical iteration of the internet as a single, universal, and immersive virtual world that is facilitated by the use of virtual reality (VR) and augmented reality (AR) headsets. Additionally, the metaverse is a network of three-dimensional (3D) worlds focused on social connection.

The purchase of the wearable article and the concurrent minting of the NFT may take place through any NFT minting and/or trading platform. Minting the NFT may put the NFT on a blockchain with a unique encrypted identifier that verifies the transaction and the ownership. A digital wallet, such as a crypto wallet, may be used to mint the NFT and the wearable article may have the digital wallet address, the private key of the digital wallet, and/or the unique cryptographic code of the NFT cast, carved, etched, engraved, printed, and/or inked into the article. The digital wallet may verify the transaction and provide access to the NFT via public addresses and private keys. In some embodiments, the purchase of the wearable article concurrently generates an NFT having a unique cryptographic code and transmits the cryptographic code to the digital wallet of the purchaser. Thus, the NFT may be cryptographically linked to a virtual representation of the wearable article with ownership data of the NFT associated with the digital wallet of the owner of the NFT. The unique digital identifier may provide security for protecting the ownership of the concurrently minted NFT.

Digital assets may be exchanged across digital asset trading platforms, including centralized and decentralized finance platforms, or through peer-to-peer technologies. Because embodiments of the invention encompass both the digital asset and the physical piece, to return either piece, trade either piece or transfer either piece to another person, in some embodiments, both the physical wearable article as well as the digital asset may need to be returned, traded, and/or transferred together.

Aspects of the invention include a method of concurrently minting a digital asset associated with a wearable article upon purchase of the wearable article, wherein the wearable article includes a physical marking denoting a unique digital identifier that is associated with the digital asset. The digital asset may be a fungible token. The digital asset may be a non-fungible token. The digital asset may be cryptographically linked to a virtual representation of a respective item. In some embodiments, the item is a digital good, a physical good, a digital service, a physical service, a digital experience, or a physical experience.

In some embodiments, the method may include generating a non-fungible digital token having a unique token identifier and concurrently generating a piece of jewelry having a unique digital identifier associated with the non-fungible digital token. The unique digital identifier may be associated with the digital wallet used to purchase the wearable article and/or the NFT. The unique digital identifier may be cast, carved, etched, engraved, printed, and/or inked into the article.

The method may include the steps of creating a physical, wearable article; upon purchase of the wearable article by a buyer, opening a crypto wallet to buy currency to pay marketplace fees; uploading a digital representation of the wearable article to a blockchain system, wherein the digital asset is created and rendered into a part of the blockchain as a public record, with a unique digital identifier. The digital object or file may be stored in this decentralized database or distributed ledger, such that it is impossible to edit, modify, or delete it.

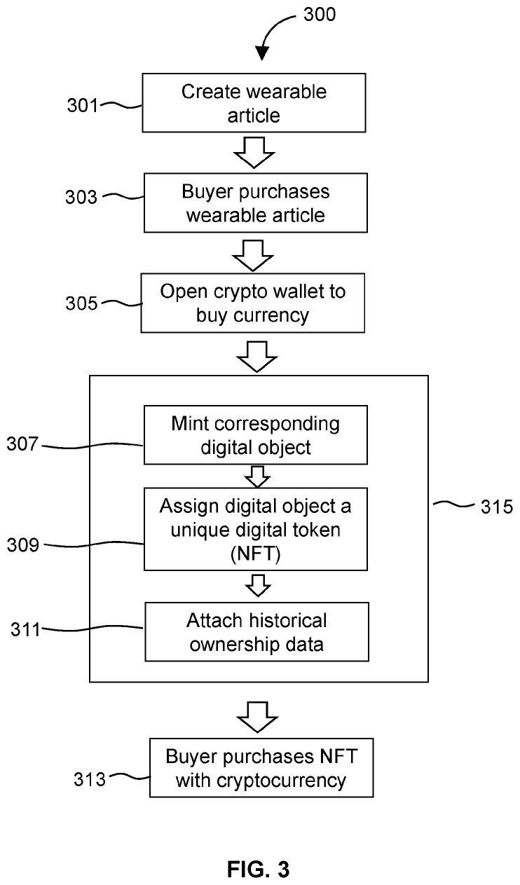

FIG. 3 illustrates a workflow 300 for a method of concurrently minting an NFT associated with the purchase of a wearable object. The method includes creating 301 the physical wearable article. The wearable article may be created by the seller or on behalf of the seller. The buyer may first purchase 303 the wearable article. To facilitate the purchase of the wearable article/and or the minting of the NFT, the method includes opening 305 a crypto wallet to buy currency to pay marketplace fees. The crypto wallet may be opened by the seller or by the buyer in which case the crypto wallet may be used to pay for the purchase of the wearable article and/or the associated NFT. The NFT is minted 307 on a blockchain system 315, for example the Ethereum blockchain. In this non-limiting embodiment, the purchaser may purchase the physical wearable article or object and concurrently separately purchase the NFT using cryptocurrency. In other embodiments as described in detail below, the wearable article is purchased and the NFT is transferred to the purchaser as part of the transaction for the product as a whole. In this embodiment, there may be no cryptocurrency cost to the purchaser.

The minting 307 process may include uploading a digital file representing the wearable article. When the NFT token is created it may store metadata about the digital file or the digital asset. The components or details of this NFT token metadata may include the artist or creator of the item, the description of the item, the price, the NFT creation date, the ownership of the item, specifications such as royalties, the transaction history of the asset, the new owner, and the location links of the file representing the NFT. This data may be stored on a distributed file system, such as a decentralized IPFS (Interplanetary File System) server. An IPFS is a protocol and peer-to-peer network for storing and sharing data in a distributed file system. The NFT may be used for various purposes for example, verifiable proof of a unique digital item, and to prove authenticity and ownership of the digital asset.

The NFT may be minted through a smart contract that assigns ownership and manages the transferability of the NFT. For example, when the NFT is created or minted, code stored in a smart contract is executed. The code conforms to different standards, such as ERC-721, and the information is added to the blockchain where the NFT is being managed. ERC-721, Ethereum Request for Comments, is a data standard for creating non-fungible tokens. The minting process, thus, may include creating a new block, validating information, recording the information into the blockchain.

Minting 307 confirms the NFT as an asset on the blockchain, and the owner's account is updated to include the asset making it possible for it to then be traded or verifiably “owned.” These transactions are added to the block and immortalized on the chain.

Minting 307 the NFT may include turning the digital file into a crypto collectible, digital object, or digital asset on a blockchain 315 such as the Ethereum blockchain. Thus, the minting 307 process may render the digital asset into a part of the blockchain as a public record. The digital object or file may be stored in this decentralized database or distributed ledger, such that it is impossible to edit, modify, or delete it. Minting may be defined as the process of uploading a specific item onto the blockchain. Or minting may be defined as the process by which the digital asset or content associated with the wearable article becomes part of the a blockchain such as the Ethereum blockchain. The minting 307 process may turn the file into a crypto asset easily traded or bought with cryptocurrencies on a digital marketplace. During the minting 307 process, the creator of the NFT may choose to schedule royalties from a subsequent sale or sales.

Once created, the digital asset (e.g. digital object, collectable, item) is assigned 309 a unique digital identifier, for example, a digital token representing the NFT. The unique digital identifier may provide the identity of the digital asset and/or the associated physical wearable object. Ownership data is attached 311 to the digital asset, thus the buyer owns the NFT, the digital representation of the wearable article, and the wearable article.

The buyer may purchase 313 the NFT using cryptocurrency. The buyer may use a digital wallet to purchase cryptocurrency for purchasing 313 the NFT.

Because embodiments of the invention encompass both the digital asset and the physical piece, to return either piece, trade either piece or transfer either piece to another person, in some embodiments, both the physical wearable article as well as the digital asset may need to be returned, traded, and/or transferred together.

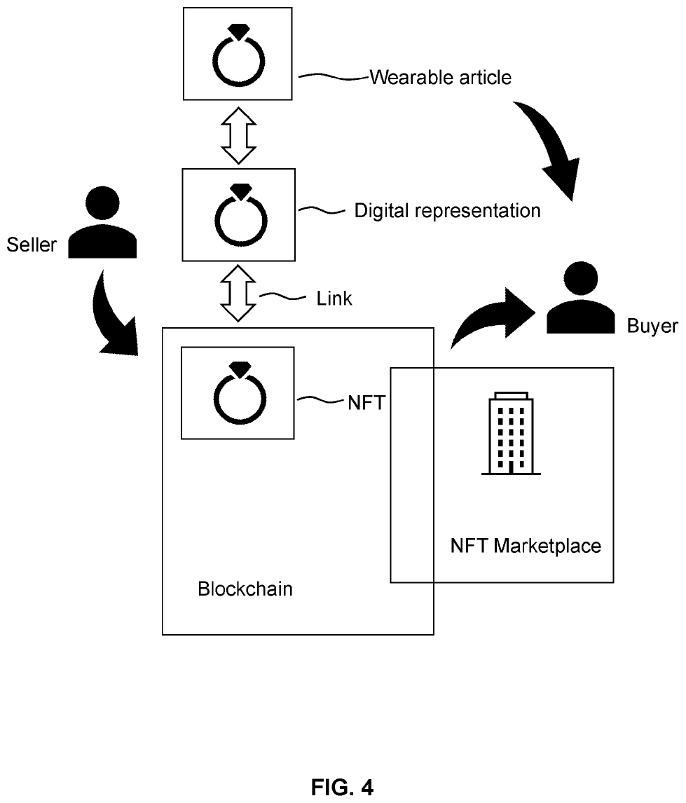

FIG. 4 illustrates a block diagram illustrating the subsequent purchase of the NFT from one user to another. Digital assets may be exchanged across digital asset trading platforms, including centralized and decentralized finance platforms, or through peer-to-peer technologies. Exchanges and wallet services, such as MetaMask and MyEtherWallet, may facilitate these transactions. An NFT can only have one owner at a time, and ownership is managed through the uniqueID and metadata that no other token can replicate.

Transactions involving the buying and selling of the digital asset and the wearable article may take place with the use of a digital wallet on an NFT marketplace. An NFT marketplace may be a platform, such as a blockchain system, where NFTs can be stored, displayed, traded, and minted. As shown in FIG. 4, the owner of the wearable article also owns the NFT which may provide ownership data and a link to the digital representation of the wearable article. As noted above, the NFT may include the right to wear the digital representation of the wearable article in the metaverse (i.e., virtual world), while also validating and safeguarding ownership of the digital asset. Thus, the transfer of ownership of the digital asset may necessarily include the transfer of ownership of the physical wearable article.

In some embodiments, the physical marking on the wearable article is a digital wallet address. The method may include storing, in the digital wallet, an inventory of digital assets that are associated with an owner of the digital wallet.

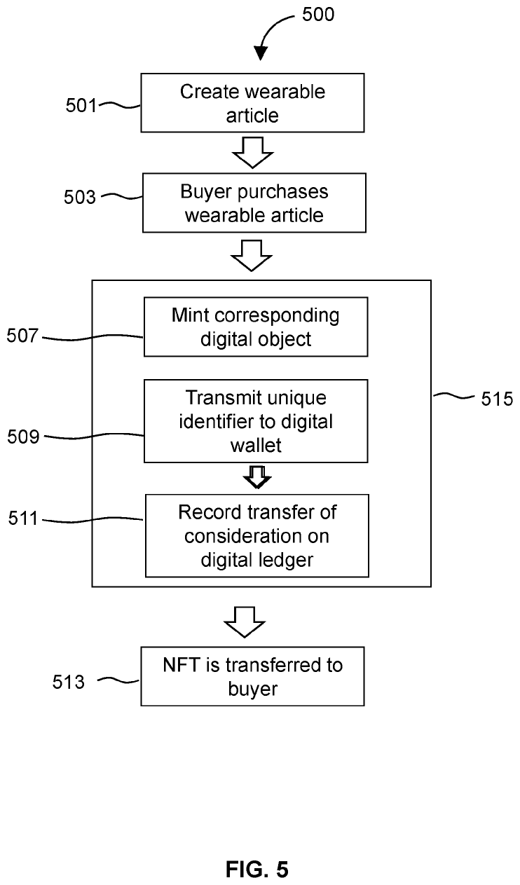

As illustrated in FIG. 5, in some embodiments, the method includes a workflow 500 for purchasing the wearable article and then transferring the NFT to the purchaser from the seller with no cryptocurrency cost to or exchange by the purchaser. For example, in a non-limiting embodiment, the wearable article may be created 501 and the NFT minted 507 before the buyer purchases 503 the product. The wearable article may be created and the NFT minted after the buyer purchases the article or, as noted above, the NFT may be minted concurrently with the purchase of the article. The method workflow 500 may include purchasing 503 the wearable object wherein purchasing the wearable article concurrently generates 515 the cryptographic token. The cryptographic token may be minted 507 and at least one of a digital address and cryptographic code may be transmitted 509 to a digital wallet, wherein the unique cryptographic code represents a transfer of consideration 511 on a digital ledger of transactions from the digital wallet associated with an owner in exchange for the wearable article and the associated cryptographic token, such that ownership of the NFT is transferred 513 to the buyer of the wearable article.

The method may further include cryptographically linking the NFT to the virtual representation of the item on the cryptographic ledger, and associating ownership data of the non-fungible token to an account of an owner of the item on the cryptographic ledger. Associating the ownership of the NFT to an account of an owner of the item may include transmitting the unique digital asset code to a distributed blockchain ledger to record on a distinct record block the transfer of the cryptographic digital asset to the purchaser. The transmittal of the unique cryptographic code may record and validate the purchase of the digital asset. The method includes transmitting to the purchaser a unique key or cryptographic code or address that correlates to ownership of the cryptographic token.

The digital ledger of transactions may be a blockchain network. For example, the blockchain network may be Ethereum, Solana, Flow, Polygon, World Asset exchange (WAX), Binance Smart Chain (BSC), Tezos, and Fantom.

In some embodiments, purchasing the wearable article further transfers exclusive rights to use the wearable article in a virtual reality (VR) and/or augmented reality (AR) social network. For example, the NFT may be cryptographically linked to a virtual representation of the NFT with ownership data of the NFT associated with the digital wallet of the owner of the NFT.

As noted above, the digital asset, for example the NFT, concurrently minted with the purchase of the wearable article, may have a design related to the physical design of the wearable article. In some embodiments, the wearable article is a piece of jewelry as described above, for example a ring, a bracelet, a necklace, a watch, one or more earrings, a pin, anklet, headband, headpiece, and a pendant. Thus, methods of the invention provide for generating a piece of jewelry wherein the physical marking is cast, carved, etched, engraved, printed, and/or inked into the article.

In some embodiments, the digital asset is a cryptographic token having a unique cryptographic code. Thus, the physical marking on the wearable article may comprise a set of alphanumeric characters denoting a digital address associated with a transaction involving the cryptographic token. For example, the cryptographic code may be stored in a digital wallet. The digital wallet may have a unique digital wallet address. The digital wallet may have a unique digital private key associated with the wallet. In some embodiments, the digital address and/or the cryptographic code comprise data for providing at least one of: access to the digital asset; verification of ownership of the digital asset; and one or more transactions involving the digital asset.

The transaction may be one or more of purchase of the digital asset and wearable article, sale of the digital asset, trading of the digital asset, and transferring ownership of the digital asset. By providing both a physical piece and an NFT as a single product, in one embodiment, one must actually exchange (i.e., trade, sell, transfer, etc.) the physical piece to another person in order to also effectuate the transfer of the associated NFT, thereby further strengthening the security and validity over ownership. Likewise, in some embodiments, one must exchange the NFT to also effectuate a transfer of the associated physical object. Thus, in non-limiting embodiments, the transfer of ownership includes transferring ownership of both the NFT and the wearable article as a single entity. Alternatively and additionally, ownership of the NFT may be transferred without transferring ownership of the wearable article and vice versa. For example, ownership of the NFT and/or wearable article may be transferred without having to also exchange (i.e. trade, sell, transfer, etc.) the NFT and/or the physical wearable object. Similarly, the ownership of the physical object may be transferred without also having to transfer ownership of the NFT.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

1. A wearable article comprising a physical marking denoting a unique digital identifier that is associated with a digital asset.

2. The wearable article of claim 1, wherein the wearable article is a piece of jewelry.

3. The wearable article of claim 2, wherein the piece of jewelry is selected from the group consisting of a ring, a bracelet, a necklace, a watch, one or more earrings, a pin, an anklet, a headband, a headpiece, and a pendant.

4. The wearable article of claim 1, wherein the physical marking is cast, carved, etched, engraved, printed, and/or inked into the article.

5. The wearable article of claim 1, wherein the digital asset comprises a cryptographic token having a unique cryptographic code.

6. The wearable article of claim 5, wherein the cryptographic token is selected from the group consisting of a payment token, a utility token, a security token, and a non-fungible token (NFT).

7. The wearable article of claim 5, wherein the physical marking on the wearable article comprises a set of alphanumeric characters denoting a digital address associated with a transaction involving the cryptographic token.

8. The wearable article of claim 7, wherein the digital address is associated with the unique cryptographic code and is stored in a digital wallet.

9. The wearable article of claim 7, wherein at least one of the digital address and cryptographic code comprises data for providing at least one of: access to the digital asset; verification of ownership of the digital asset; and one or more transactions involving the digital asset.

10. The wearable article of claim 9, wherein the one or more transactions comprises at least one of sale of the digital asset, trading of the digital asset, and transferring ownership of the digital asset.

11. The wearable article of claim 9, wherein at least one of the digital address and cryptographic code can be used to verify that a digital wallet associated with an owner of the wearable article holds the cryptographic token and indicates exclusive ownership of the digital asset.

12. The wearable article of claim 5, wherein a purchase of the wearable article concurrently generates the cryptographic token and transmits at least one of a digital address and cryptographic code to a digital wallet, wherein the unique cryptographic code represents a transfer of consideration on a digital ledger of transactions from the digital wallet associated with an owner in exchange for the wearable article and the associated cryptographic token.

13. The wearable article of claim 12, wherein transmittal of the unique cryptographic code records and validates the purchase of the digital asset.

14. The wearable article of claim 12, wherein the digital ledger of transactions is a blockchain network.

15. The wearable article of claim 14, wherein the blockchain network is selected from the group consisting of Ethereum, Solana, Flow, Polygon, World Asset exchange (WAX), Binance Smart Chain (BSC), Tezos, and Fantom.

16. The wearable article of claim 12, wherein the cryptographic token is a non-fungible token (NFT).

17. The wearable article of claim 16, wherein a design of the NFT is related to a physical design of the wearable article.

18. The wearable article of claim 17, wherein the purchase of the wearable article further transfers exclusive rights to use the wearable article in a virtual reality (VR) and/or augmented reality (AR) social network.

19. The wearable article of claim 18, wherein the NFT is cryptographically linked to a virtual representation of the NFT with ownership data of the NFT associated with the digital wallet of the owner of the NFT.

20. The wearable article of claim 18, wherein the virtual representation of the NFT is associated with the physical design of the wearable article.
